(19) United States
(12) Patent Application Publication
(10) Pub. No.: US 2008/0000153 A1
(43) Pub. Date: Jan. 3, 2008

(54) Temporary Structural Body for Seeding and Planting

(76) Inventors: Nobuo Sugiyama, Yokohama-shi (JP); Takuya Ookubo, Yokohama-shi (JP); Yousuke Okada, Kawasaki-shi (JP); Michihiro Shinya, Hino-shi (JP)

Correspondence Address: JACOBSON HOLMAN PLLC, 400 SEVENTH STREET N.W., SUITE 600, WASHINGTON, DC, 20004, US

(21) Appl. No.: 11/794,899

(22) PCT Filed: Jan. 7, 2005
(86) PCT No.: PCT/JP05/00442

§ 371 Date: Jul. 9, 2007

(51) Int. Cl. A01G 9/02; A01G 27/00

(52) U.S. Cl. 47/47

(57) ABSTRACT

A temporary structural body for seeding and planting comprises seeding and planting panels (6), each having a seeding and planting block (7) in a frame structure (8); a supporting structure (1) for the panels; and mounting means (4, 9) for detachably mounting the panels on the supporting structure. The supporting structure includes at least two posts (3), and horizontal members (4) installed across these posts. Backside or lateral sides of each of the panels is mounted on the horizontal member or the post of the supporting structure by the mounting means, whereby a seeding and planting face, which has a number of the panels continuously or discontinuously disposed, is formed on a front side of the supporting structure. The temporary structural body for seeding and planting can be provided, which are optimally suitable for outdoor and indoor seeding and planting, which can be easily assembled and disassembled without being integrally incorporated into a permanent construction, and which enables partial exchange of the panels and easy maintenance of the panels.

### TECHNICAL FIELD

The present invention relates to a temporary structural body for seeding and planting, which can be placed indoors and outdoors with use of seeding and planting panels.

### BACKGROUND TECHNOLOGY

In recent years, seeding and planting panels have been used for greening of surfaces of permanent constructions such as buildings, retaining walls, and so forth. The seeding and planting panel is constituted from a required panel frame and a seeding and planting mat or block contained in the frame. The mat or block is a planting and seeding base. In general, such panel frames are fixedly secured to surfaces of existing constructions, such as building wall surfaces, roofs or retaining walls by means of adhesives or fitting jigs (for example, JP-A 11-293689 (referred to as Patent Document-1 hereinafter) and JP-A 2001-214447 (referred to as Patent Document-2 hereinafter)).

Further, seeding and planting panels are proposed in JP-A 2001-320968 (referred to as Patent Document-3 hereinafter), which are disposed between vertical frames laterally spaced a distance and which are attached to the vertical frames at side portions of the panels. The vertical frames for these seeding and planting panels are attached to anchor plates which are fixed to wall surfaces of permanent constructions by means of bolts and nuts.

However, those panels as described in Patent Documents-1 to 3 are securely fixed onto the wall surface of the constructions or the like, and integrally incorporated into the constructions so as to be permanent structural elements thereof. Therefore, it is impossible or troublesome to exchange the panels, and also, they cannot be easily moved.

Furthermore, according to those prior art techniques, the seeding and planting panels are fixed to the wall surface of the construction or the like in parallel with the wall surface, and backside faces of the panels are concealed from the outside after fixing, and therefore, maintenance work cannot be easily carried out. In addition, since those panels are intended to be used as exterior installation, they cannot be used for seeding and planting of interior wall surfaces and so forth.

It is an object of the present invention to provide a temporary structural body for seeding and planting, which can be easily assembled and disassembled without being integrally incorporated into the permanent constructions, which can facilitate partial replacement and maintenance of the seeding and planting panels, and which is suitable for both of outdoor greening and indoor greening.

### DISCLOSURE OF THE INVENTION

In order to accomplish the above object, the present invention has the features as described hereinafter.

The temporary structural body for seeding and planting as defined in claim 1 comprises seeding and planting panels, each having a frame structure and a seeding and planting block contained in the frame structure; a supporting structure for the panels; and mounting means for detachably mounting the panels on the supporting structure. The supporting structure includes at least two posts and horizontal members installed across the posts. Backside faces or both sides of the panels are attached to the horizontal members or the posts with use of the mounting means, so that a seeding and planting face is formed by a number of the panels which are continuously or discontinuously disposed on a front face of the supporting structure.

The temporary structural body for seeding and planting as defined in claim 2 further comprises a liquid feeding means for feeding water and/or liquid fertilizer to the seeding and planting panels, in addition to the arrangement as defined in claim 1.

The seeding and planting block in the seeding and planting panel is made by a planting and growing base material (for example, a peat moss) with seeds or seedlings being sown or planted. As the planting and growing base material, various kinds of base materials can be used, which can ensure desired rooting and growth of plants. The size of the seeding and planting panel is appropriately set in consideration of the size of the temporary structural body, handling convenience, balance of the seeding and planting face, and so forth.

The frame structure of the seeding and planting panel may be formed by plates, rods, wire rods or the like, and its material, arrangement or shape is not limited, so long as the frame structure is capable of containing the seeding and planting block therein. For example, the frame structure is constructed from a peripheral frame made of band plates surrounding the outer peripheral face of the block and a backside frame overlaid on the block from its backside. In a case where flat plates are used for the frame structure, a porous plate such as a punched plate may be employed.

In a case where the peripheral frame of the frame structure is formed by the band plates, the outer peripheral face of the seeding and planting block is surrounded by the band plates spaced a required distance in a direction of the depth of the block. In a case where the back side frame is formed by the band plates, it can be formed by a plurality of band plates which are overlaid on the backside face of the block and which are spaced a required distance vertically.

When the frame structure is formed by bending wire rods, the frame structure is configured to support a bottom portion, right and left sides and front and rear central portions of the seeding and planting block.

The supporting structure for supporting the panels comprises, e.g., at least two standing posts spaced a required distance from each other, and horizontal members installed between the posts.

It is preferable that the supporting structures are classified into an indoor-installation type and an outdoor-installation type and that the structures are selected to meet the respective types. It is desirable that the supporting structure is self-sustainable. If desired, the supporting structure may be so arranged as to be temporarily secured to an interior wall surface or the like. Rod-like members (such as an angular member, a round bar, a rectangular or round pipe) are used as the post. The self-sustainable supporting structure may be provided with sliding members on its bottom portion so as to be movable.

The supporting structure may be constructed by three posts standing in three positions and horizontal members installed between the adjacent posts. In such a case, three seeding and planting faces can be formed by seeding and planting blocks, which are mounted on the horizontal members between the posts by the mounting means.

Furthermore, the supporting structure can be a self-sustainable framework by front posts standing with a required span, rear posts standing with a required span behind the front posts, connection rods for connecting the front and rear posts, horizontal members connecting the front posts with each other, and horizontal members connecting the rear posts with each other. In the supporting structure having such a framework, front and rear seeding and planting faces are formed by mounting the seeding and planting panels on the front and rear faces of the structure.

The horizontal member of the supporting structure can be constituted from a straight rod member to be mounted between the posts, e.g., a rail member with an upwardly opening groove having a generally U-shaped cross-section. In this case, the horizontal member constitutes the mounting means in cooperation with hook-like hanging members attached to the backside face of the seeding and planting panel, and the panel is supported on the horizontal member slidably in its longitudinal direction by the hanging member engaging with the groove. The hanging member may be integrally formed on a backside frame of the panel.

The horizontal member of the supporting structure may be a U-shaped curved rod with a large curvature, rather than the straight rod. The horizontal members are vertically spaced from each other, each being fixed to the supporting posts in longitudinally plural positions of the horizontal member. The seeding and planting panels are mounted on the horizontal members by the mounting means and are arranged in a generally horseshoe shape in its plan view, wherein the panels are spaced from each other vertically and horizontally.

The mounting means is not limited to that having a specific constitution, so long as it can detachably mount the seeding and planting panel on the supporting structure. If the posts and the horizontal members of the supporting structure are made of round pipes, a clamping device fixed on the backside frame of the panel may be used as the mounting means.

The seeding and planting panels are attached to the supporting structure by the mounting means so that the panels are spaced vertically and longitudinally, or arranged in a continuous or discontinuous plane formation.

Further, the seeding and planting panel is not always mounted, with a front face of the seeding and planting block being vertical, on the supporting structure by the mounting means. The mounting means may be arranged to mount the panel on the supporting structure with the front face of the block being inclined backwardly. Preferably, the mounting means is arranged to adjust the angle of backward inclination of the block.

The liquid feeding means in the invention of claim 2 includes, e.g., a liquid source, pipe lines for feeding water or liquid fertilizer from the liquid source to each of the seeding and planting panels, nozzles at ends of the pipe lines for flowing out the water or liquid fertilizer, and a liquid feeding pump provided on the pipe lines. The nozzle is detachably inserted into the seeding and planting block of the panel, or inserted between the adjacent blocks. The water or liquid fertilizer is fed from the liquid source to the panels through the pipe lines by the liquid feeding pump.

The pipe lines comprises a main pipe equipped behind the seeding and planting panels, and a number of thin tubes branched forward from the main pipe. A needle-like nozzle is attached to a tip of each of the tubes for spraying the water or liquid fertilizer. Alternatively, the pipe line may be installed inside of an upper frame member of the peripheral frame, so that the water or the like is fed through a number of apertures of the pipe wall to the seeding and planting block. The upper frame member may be arranged to have an openable lid function.

The liquid feeding means may be provided with a timer for operating the liquid feeding pump, so that water or liquid fertilizer is timely fed to the seeding and planting panel at the preset time by the pump.

The supporting structure includes a detachable tray in its lower portion, which receives excess liquid from the seeding and planting panels. The liquid in the tray is returned to the liquid feeding means for recirculating the liquid.

Preferably, the seeding and planting panels, e.g., the panels of indoor-installation type, are disposed in a front face area between the posts to form a vertically and horizontally continuous plane formation entirely covering the overall front face area. In a case where a number of the panels are disposed to form a vertically and horizontally discontinuous plane formation, decorative panels and/or box-shaped panels are disposed in the discontinuous sections. Thus, the front face of the supporting structure is entirely covered with the seeding and planting panels, and the decorative panels and/or the box-shaped panels.

All of the seeding and planting panels, the decorative panels and the box-shaped panels can be detachably mounted on the supporting structure by the mounting means. The backside faces of the decorative panels and the box-shaped panels are detachably mounted on the supporting structure by the mounting means.

### BRIEF DESCRIPTION OF THE DRAWINGS

FIG. 1 is a front elevational view showing one embodiment of a temporary structural body for seeding and planting according to the present invention, in which one of the seeding and planting panels is removed therefrom.

FIG. 2 is a perspective outside view showing the panel for the temporary structural body as shown in FIG. 1.

FIG. 3 is a perspective view which shows a mounting condition of frame structures of the panels on a supporting structure.

FIG. 4 is an enlarged side view of the temporary structural body.

FIG. 5 is an enlarged plan view showing a connection between a horizontal member of the supporting structure and a post thereof.

FIG. 6 is a perspective outside view showing an example of means for feeding liquid to the panels.

FIG. 7 is a front elevational view showing another embodiment of the temporary structural body according to the present invention.

FIG. 8 is a rear perspective view of a decorative panel used in the structural body as shown in FIG. 7.

FIG. 9 is a perspective outside view showing another example of the means for feeding liquid.

FIG. 10 is a front elevational view showing still another embodiment of the temporary structural body according to the present invention.

FIG. 11 is a side elevational view of the temporary structural body as shown in FIG. 10.

FIG. 12 is an enlarged plan view showing a connection between the post of the supporting structure and the horizontal member thereof.

FIG. 13 is a front elevational view of another example of the temporary structural body as shown in FIG. 10.

FIG. 14 is a side elevational view of the temporary structural body as shown in FIG. 13.

FIG. 15 is a perspective outside view showing an outdoor-installation type of the temporary structural body, which is another embodiment of the present invention.

FIG. 16 is a side elevational view of the frame structure of the panel used in the temporary structural body as shown in FIG. 15.

FIG. 17 is a front elevational view of the frame structure as shown in FIG. 16.

FIG. 18 is a rear view of the frame structure as shown in FIG. 16.

FIG. 19 is a perspective outside view showing the other embodiment of an outdoor-installation type temporary structural body according to the present invention.

FIG. 20 is a perspective outside view showing another example of the frame structure used in the present invention.

FIG. 21 is a perspective view generally showing an application of the panel with the frame structure as shown in FIG. 20.

### BEST MODE FOR CARRYING OUT THE INVENTION

Embodiments of the present invention illustrated in the drawings is described in detail hereinafter.

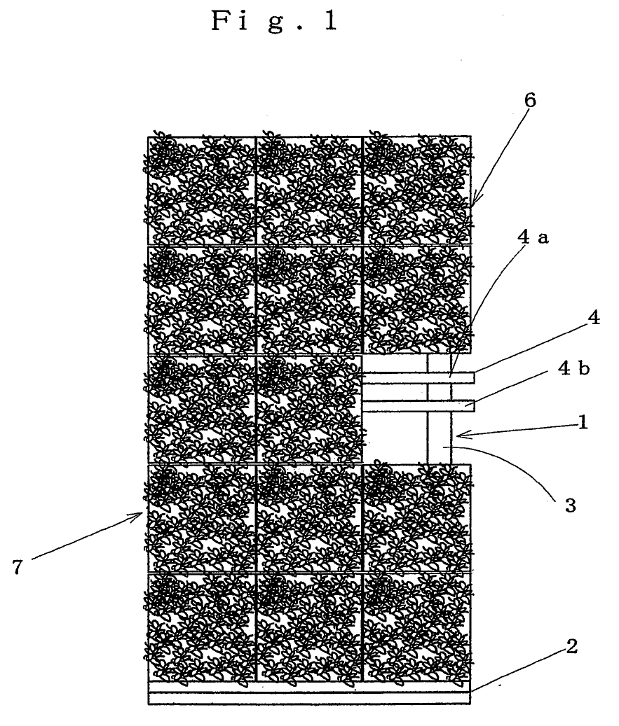

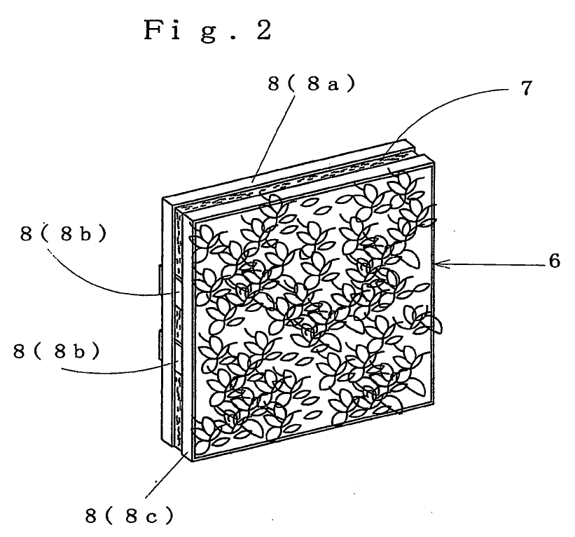

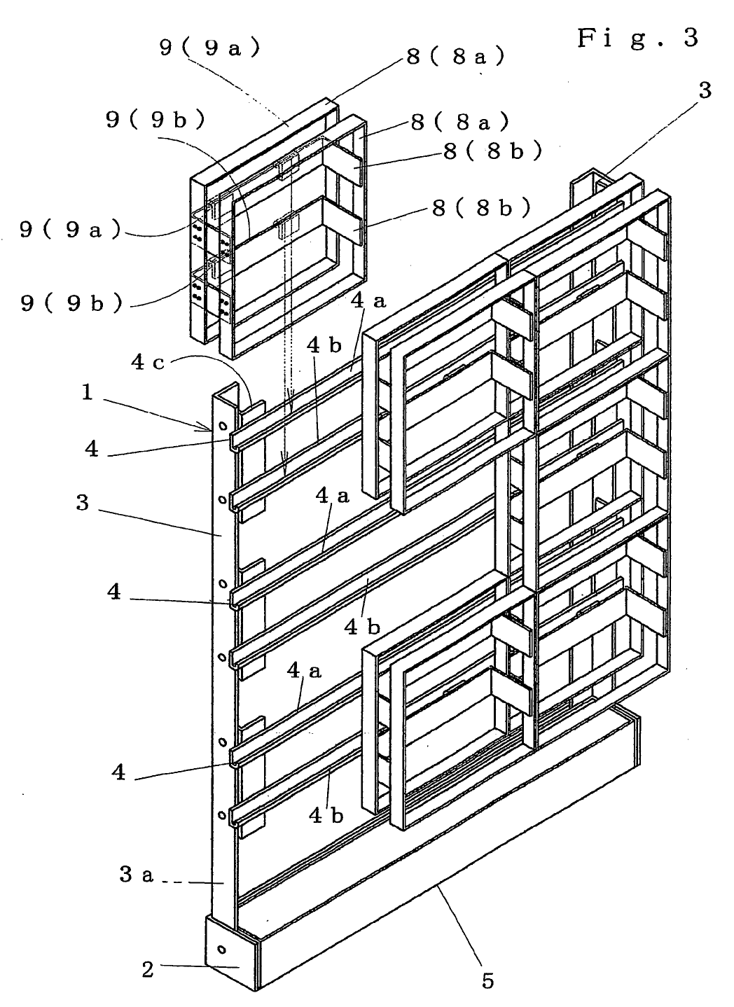

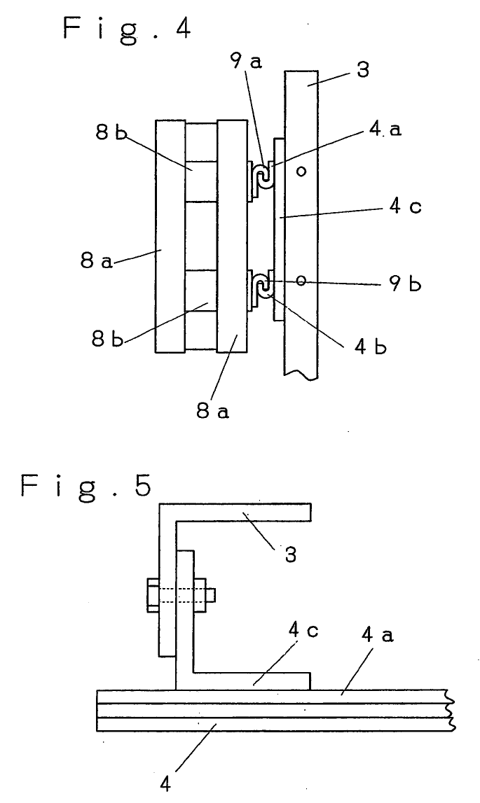

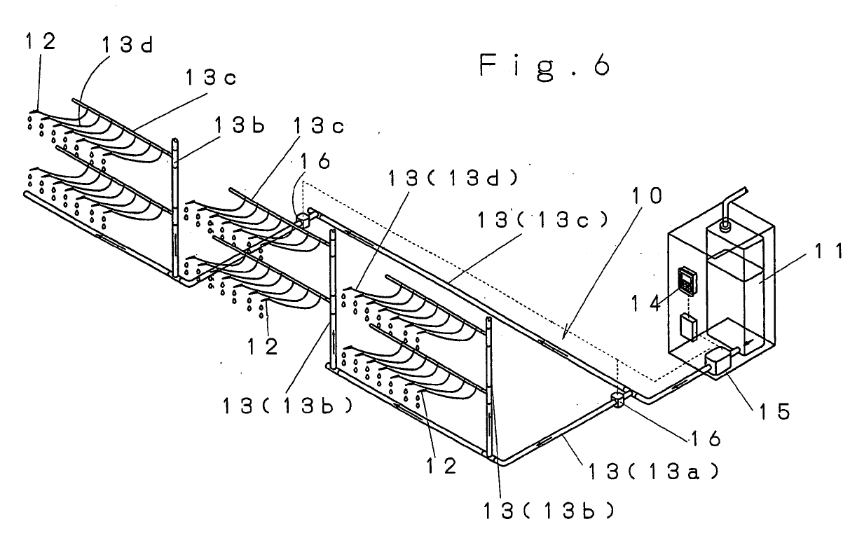

FIG. 1 is a front elevational view of an indoor temporary structural body for seeding and planting, which is an embodiment of the present invention, wherein one of seeding and planting panels is removed therefrom. FIG. 2 is a perspective outside view of the seeding and planting panel. FIG. 3 is a perspective view showing an assembled condition of a supporting structure and frame structures of the seeding and planting. FIG. 4 is an enlarged side elevational view of the temporary structural body for seeding and planting, and FIG. 5 is an enlarged plan view showing a joint between a supporting post of the supporting structure and a horizontal member. FIG. 6 is a perspective outside view showing an example of means for feeding liquid to the seeding and planting panels.

In FIGS. 1 and 3, reference numeral 1 denotes a supporting structure constituting a framework of the temporary structural body for seeding and planting.

The supporting structure 1 is constituted from a pedestal 2, right and left supporting posts 3, 3 standing on the pedestal 2 with a required span, and horizontal members 4 extending horizontally between the posts 2.

As shown in FIGS. 3 and 4, the posts 3 are made of L-shaped angle members, and base end portions 3a of the posts 3 are fixed to the pedestal 2 in such a condition that their grooves are oriented inwardly and opposed to each other.

The horizontal member 4 is constituted from upper and lower rails 4a, 4b and L-shaped brackets 4c fixed to both ends of the rails 4a, 4b. Each of the rails 4a, 4b has a generally U-shaped or J-shaped cross-section and is formed with an upwardly opening groove. The grooves extend horizontally in parallel, spaced a predetermined distance. The L-shaped bracket 4c is detachably secured to one side of the post 3 by means of bolts and nuts (FIG. 5). The horizontal members 4 are horizontally mounted on the posts 3 in correspondence with the number of stages of the seeding and planting panels 6. The horizontal members 4 independently and detachably support the panels 6 on the front of a space between the posts. As regards the temporary structural body as shown in FIG. 1, five stages of the horizontal members are mounted, vertically spaced a given interval (only three stages on the lower side are illustrated in FIG. 3).

The pedestal 2 has a box configuration without a front plate, and the base end portions 3a of the posts 3 are fixed to the pedestal at inner corners thereof on both sides. A tray 5 for receiving an excess quantity of water, liquid fertilizer or the like is inserted in the pedestal 2 so as to be movable in forward and backward directions and detachable therefrom. A draining hose (not shown) may be provided so as to be in communication with the tray 5.

Reference numeral 6 denotes the seeding and planting panel mounted on a front face of the supporting structure 1, and the panels are disposed vertically in 5 stages and horizontally in 3 columns (totally 15 panels).

The panel 6 is constituted from a seeding and planting block 7 and a frame structure 8 containing and carrying the block 7.

The block 7 has a block body in which seeds or seedlings are sown or planted. The block body may be formed by binding a three-dimensional fibrous mass with a binding agent and drying the resultant. The three-dimensional fibrous mass has a structure in which fibers of a plant residue such as a peat moss are three-dimensionally entangled and which possesses a large porosity and abundant water permeability. The binding agent contains natural starch glue or a water-soluble polymer such as PVA (polyvinyl alcohol), and its ester, an acetic acid ester, polymethyl cellulose or the like. This seeding and planting block body has a lightweight property and an excellent elasticity, and ensures rooting of the plant. It may be formed in a rectangular parallelepiped shape, which is, e.g., 30 cm×30 cm square and 8.5 cm thickness, although its size is not specifically limited thereto.

As shown in FIGS. 2 and 3, the frame structure 8 is constituted from peripheral frames 8a surrounding a peripheral face of the block 7 (upper, lower, right and left faces), and backside frames 8b overlaid on the block 7 along its backside, left side and right side faces.

Each of the peripheral frames 8a is formed by band plate members having a given width, and the two frames 8a surround the peripheral face of the block 7, one surrounding a front part of the peripheral face and the other surrounding a backside part thereof. A surface of a depthwise intermediate part of the block 7 is exposed in a frame-like formation between the two band zones of the peripheral frames 8a, 8a (FIG. 2).

The backside frame 8b is made by bending a band plate member of a given width, similarly to the frame 8a. The frame 8b has a backside portion and side portions arranged in a formation of letter “C” The frame 8b is integrally secured to the peripheral frames 8a by fixing the side portions of the frame 8b to side inner faces of the frames 8a (FIG. 3). The frames 8b are provided on backside of the block 7 in a form of stripes, and they are vertically spaced a distance equal to the distance between the upper and lower rails 4a, 4b of the aforementioned horizontal member 4.

Upper hooks 9a and lower hooks 9b are provided on the backside portions of the frames 8b, so that the hooks 9a, 9b are slidably hung on the upper and lower rails 4a, 4b, respectively. The upper hooks 9a are defined by right and left hook pieces, and the lower hooks 9b are defined by right and left hook pieces.

The seeding and planting panel 6 is detachably mounted on the front face of the supporting structure by the upper and lower hooks 9a, 9b of the frames 8b hanging on the upper and lower rails 4a, 4b of the horizontal member 4. The panels 6 mounted on the supporting structure 1 are horizontally and continuously arranged along the rails 4a and 4b of the horizontal member 4 in each stage, and further, vertically and continuously arranged by hanging the panels 6 on the horizontal members 4 in all of the stages. Thus, the panels 6 wholly cover the front face of the supporting structure 1, as shown in FIG. 1, without a substantial gap being formed between the panels.

The supporting structure 1 may be provided with side plates (not shown) on both sides, which cover outer sides of the panels 6 located at right and left ends. The side plates stand along the side faces of the pedestal 2 and the posts 3, and one or both of the side plates are arranged to be movable or detachable. With such an arrangement, the plates 6 can be slid along the rails 4a and 4b in each of the stages and extracted through their open side area. Such an arrangement is advantageous, particularly when replacement or maintenance of only the specific panel 6 should be carried out.

Further, a ceiling panel (not shown) is attached to the supporting structure 1 so as to cover upper faces of the panels 6 in the uppermost stage. Casters or rollers are provided on a bottom portion of the pedestal 2 for movement of the present structural body for seeding and planting. Furthermore, a backside plate is attached to the backside face of the supporting structure 1.

In the present structural body in which the panels 6 are supported by the supporting structure 1, a irrigation system 10 is equipped behind the panels 6 as liquid feeding means. The irrigation system 10 feeds water, a liquid fertilizer or the like (referred to as “water or the like” hereinafter) to the seeding and planting block 7 of each of the panels 6.

As shown in FIG. 6, the irrigation system 10 is provided with a tank 11 for storing water or the like, nozzles 12 for spraying water or the like to the seeding and planting blocks 6, and feed pipes 13 connecting the nozzles 12 with the tank 11. The tank 11 is located away from the supporting structure 1, and connected with a water feeding source such as a water service pipe or the like. Behind the horizontal members of the supporting structure 1, the feeding pipes 13 are provided with vertical pipes 13b extending along the posts 3, horizontal pipes 13c horizontally extending from predetermined positions of the vertical pipes 13b, and main pipes 13a connecting proximal ends of the vertical pipes with the tank 11.

The vertical pipes 13b are arranged by the number of the columns of the panels 6, spaced an interval corresponding to the lateral interval of the panel 6.

The horizontal pipes 13c are arranged by the number of the stages of the panels 6, spaced an interval corresponding to the vertical interval of the panels 6. A plurality of tubes 13d are connected to the horizontal pipe 13c, and the needle-like nozzles 12 are attached to ends of the tubes 13d. The needle-like nozzle 12 is provided with a single aperture or plural apertures, and is inserted into an exposed portion of the back or upper face of the seeding and planting block 6 (between the peripheral frames 8a, 8a, or between the backside frames 8b, 8b), so as to feed water or the like into the block 6.

The vertical pipes 13b and the horizontal pipes 13c are contained in a space between the posts of the supporting structure 1 and in a space between the horizontal members 4 and the backside plate.

A pump 15 and electromagnetic valves 16 are installed on the main pipe 13a, and feeding of water or the like is timed under control of a controller 14.

A method of assembly and a method of use with respect to this temporary structural body for seeding and planting is described hereinafter.

At first, the right and left posts 3, 3 are stood by tightening the base end portions of the posts 3 to the pedestal 2 with bolts and nuts. The vertical pipes 13b and the horizontal pipes 13c of the irrigation system 10 are installed in the inner space between the posts. The proximal end portions of the vertical pipes 13b are connected to the main pipe 13a for feeding water or the like.

The rails for 5 stages are horizontally provided by fixing the L-type brackets 4c of the horizontal members 4 to the side plates of the posts 3. The seeding and planting panels 6 are prepared, which contains the seeding and planting block 7 in the frame structure 8, wherein a desired plant is planted and grown therein beforehand. Since the frame structure 8 is formed by the band plate members, the panel 6 is relatively lightweight and easy to handle.

The panel 6 is mounted on the front face of the supporting structure by hanging the upper and lower hooks 9a, 9b of the backside of the panel 6 on the upper and lower rails 4a, 4b of the horizontal member 4. The panels 6 are mounted successively from the lower stage toward the upper stage by engagement of the hooks 9 with the corresponding rails 8a, 8b. Alternatively, the panels 6 may be mounted by putting the hooks 9 to the rails 8a, 8b from an end portion of the horizontal member 4.

Then, the nozzles 12 at the ends of the tubes extending forward from the horizontal pipe are inserted into the exposed portions of the seeding and planting blocks 7 of the panels 6.

After the panels 6 are continuously mounted vertically and horizontally to cover the front face of the supporting structure, the backside plate is attached thereto, and further the ceiling plate and the side plates are fixed thereto. Then, the assembly is positioned at a desired location in a room. The supporting structure 1 is fixedly secured to a wall by means of a metal fitting for preventing overturning or the like, if required.

Thus, the upright green wall face is constructed in the room. The frame structure 8 containing the seeding and planting block is made of the band plate, the peripheral face and the back face of the seeding and planting block 7 are partially and appropriately exposed, and particularly, the back face is exposed between the posts. Therefore, the seeding and planting panel 6 forming the green wall face has abundant air permeability,

When the controller 14 is operated, water or the like in the tank is periodically fed to the feeding pipes under pressure by means of the pump. An appropriate amount of water or the like under pressure is timely introduced from the nozzles 12 of the tubes into the seeding and planting blocks through the pipes 13a, 13b, 13c. The electromagnetic valves 16 control branching flow of the main pipe.

The upper and lower panels 6 are disposed to be in close proximity to each other, and the peripheral exposed portions of the seeding and planting blocks are opposed to each other. Therefore, excess water or the like of the panels 6 in the upper stage drips and penetrates into the seeding and planting blocks of the panels 6 in the lower stage. Thus, the amount of water fed to the panels 6 of the lower stage by the pipes 13 is preferably set to be smaller than that for the upper stage, owing to reduction in the diameter or the number of the openings of the nozzles 12.

Excess water passing the seeding and planting blocks of the panels 6 in the lowermost stage is received by the tray 5 of the pedestal 2, and extracted and drained therefrom, or discharged therefrom through a drain hose, when required.

The irrigation system 10 is operated in the manner as set forth above, whereby water or the like is automatically fed to the structural body for seeding and planting. Further, air is appropriately fed to the seeding and planting blocks through the exposed portions of their backside faces, and unnecessary excess water or the like does not remain within the frame structures, and therefore, rot of roots of the plants is not caused.

If the plants in a part of the seeding and planting panels 6 do not preferably grow, the side plate of the supporting structure 1 is removed or opened, and the panels 6 of the stage including the specific panel 6 with such plants are successively removed along the rails 4a, 4b in due order from the panel 6 positioned near the side plate until the specific panel 6 is removed therefrom. After the specific panel 6 is replaced with the new panel 6, the other panels 6 are mounted again by horizontally sliding them from the side of the side plate, and the side plate is attached thereto again.

If it is required to partially exchange the plants of the green face with another kind of plant or the plant for the season, the seeding and planting panels 6 can be easily exchanged in accordance with the similar procedure as set forth above.

In order to disassemble the temporary structural body for seeding and planting, all of the seeding and planting panels 6 are removed along the horizontal members 4, and then, the horizontal members 4 are detached from the posts 3. The feed pipes 13 for water or the like are removed and the posts 3 are then detached from the pedestal 2, whereby the temporary structural body is decomposed into the panels 6, the posts 3, the horizontal members 4 and the pedestal 2. The side, ceiling and backside plates are separated respectively in appropriate steps during this disassembling work.

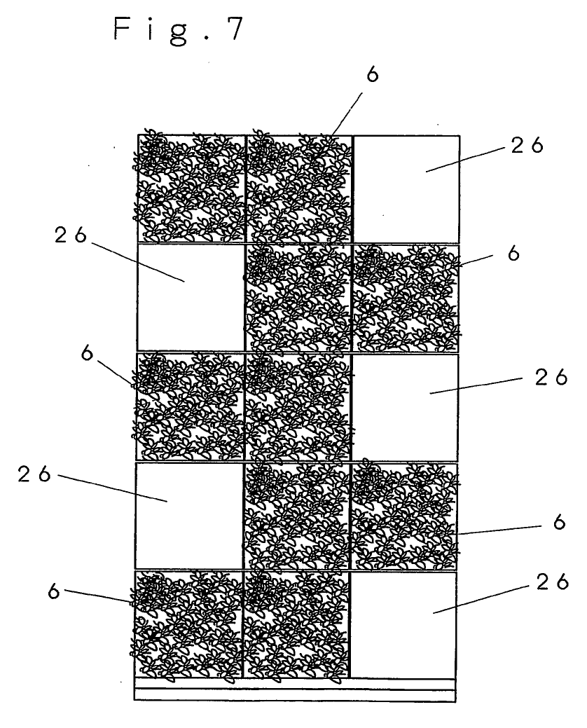

FIG. 7 is a front elevational view showing the other embodiment of a temporary structural body for seeding and planting according to the present invention.

In this embodiment, the seeding and planting face on the front side of the supporting structure is not continuously or entirely covered with the seeding and planting panels 6, but decorative panels 26 are partially disposed thereon. The decorative panels 26 as illustrated are placed in right edge sections of odd stages and in left edge sections of even stages, whereas the seeding and planting panels 6 are placed in the remaining sections.

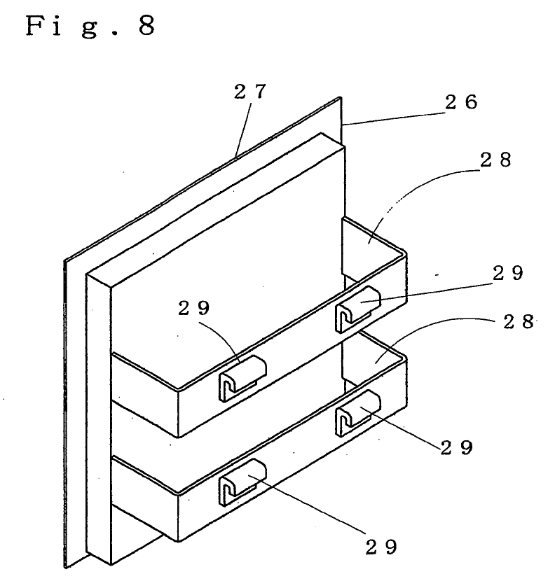

FIG. 8 shows an arrangement of the decorative panel.

The decorative panel 26 is provided with a decorating plate 27 on its front side having the same size as that of the seeding and planting panel 6. Backside frames 28, which are identical with the backside frames 8b of the panel 6, are attached to the backside of the decorating plate 27. A variety of plates may be selected as the plate 27, e.g., plates which have surfaces colored by a single color or multiple colors, or plates which have patterns, characters, paintings, photographs, designs, various advertisements, and so forth.

The decorative panels 26 are mounted on the supporting body 1 by hanging upper and lower hooks 29 of the backside frame 28 on the upper and lower rails 4a, 4b of the horizontal member 4 of the supporting structure, in the same manner as that of the aforementioned seeding and planting panels 6.

The structure of the seeding and planting panel 6 is not different from that in the aforementioned embodiment. However, in order to prevent the decorative plates 27 from being tainted with dripping water or the like fed from the irrigation system 10, it is desirable to arrange the frame 8 for the block 6 so as to entirely cover at least the peripheral face of the block 6. The backside face of the frame body 8 may be covered with a punched metal, and the nozzles 12 of the irrigation system 10 may be inserted through the openings of the metal. The punched metal ensures ventilation of the seeding and planting blocks 6 between the posts.

The arrangement of the panel is not limited to that shown in FIG. 8. For example, the panel may be so arranged that it can be pushed and attached into openings of the discontinuous sections from the front side. In this case, the hooks 29 of the backside frame 28 may be constructed to be elastic pawls which are pressed and elastically deformed by the front faces of the rails, and which are restored and engaged with the grooves of the rails after they are fitted in the grooves.

In this embodiment, box-shaped panels may be used, instead of the decorative panels.

The box-shaped panel (not shown) is a deep box-styled panel which has an open front face and which is provided at its backside face with the upper and lower hooks as set forth above. A variety of decorative articles, devices and so forth are displayed or placed in the box-shaped panel.

Further, a door may be attached to the box-shaped panel.

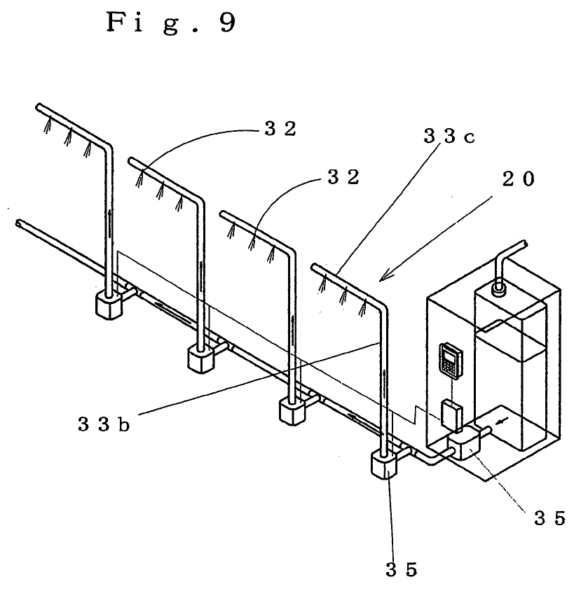

FIG. 9 shows another example of the irrigation system.

In this irrigation system 20, water is fed to the seeding and planting blocks 6 in such a manner that water is sprayed onto upper peripheral faces of the blocks 6 through a number of spraying apertures 32 formed on pipe walls of horizontal pipes 33c.

A proximal end portion of a vertical pipe 33b is connected with a main pipe 33a by means of an electromagnetic valve 36. The vertical pipes 33b are provided by the same number as that of the columns of the seeding and planting blocks 6, in the same manner as in the aforementioned embodiment. Each of the vertical pipes 33b has the length reaching the upper peripheral face of the block 6 in the uppermost stage. The horizontal pipes 33c are merely provided at the upper ends of the vertical pipes 33b. The horizontal pipes 33c may be so arranged to extend in the respective stages. In FIG. 9, reference numeral 35 denotes a pump.

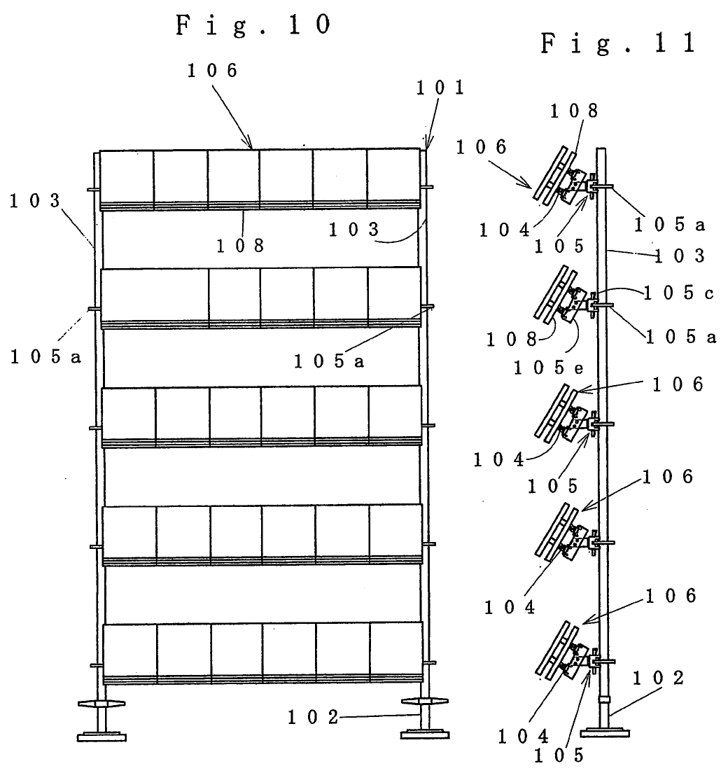

FIGS. 10 and 11 are front and side elevational views of still another embodiment of a temporary structural body for seeding and planting according to the present invention, which is to be installed mainly outdoors. It is shown in a condition that the seeding and planting blocks are removed therefrom. The arrangement of the seeding and planting block is the same as that of the aforementioned embodiments.

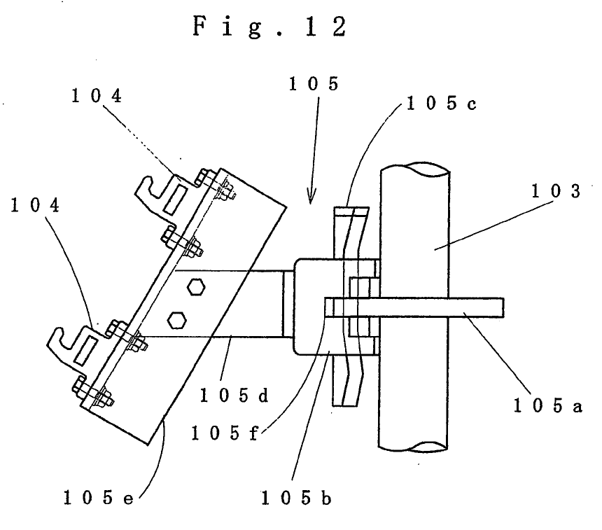

In FIGS. 10 and 11, reference numeral 101 denotes a supporting structure, which is constructed by a pair of right and left posts 103, 103 and horizontal members 104, the member 104 being installed across the posts 103 in plural stages and positioned at predetermined levels. As shown in FIG. 12, the post 103 is made of a round pipe, and the horizontal member 104 is a rail similar to that of the embodiment as shown in FIG. 3 to FIG. 5. The lower ends of the posts 103 are equipped with jack bases 102 so that the height of the post can be adjusted.

The ends of the horizontal member 104 are connected to the posts 103 by metal connectors 105. As the connector 105, a wedge type connector is used, which comprises a wedge-receiving ring 105a on the post 103, a wedge-receiving block 105b on the horizontal member 104, a wedge body 105c, a mount arm 105d, and an inclined fixing plate 105e, as shown in FIG. 12,

The ring 105a has a wedge-receiving hole (not shown) radially formed in its plate. The ring 105a is horizontally fixed onto the outer periphery of the post 103 at a predetermined level.

The wedge-receiving block 105b is provided in its intermediate portion on one side with a recess 105f, into which the plate of the wedge-receiving ring is partially insertable, and the block 105b has a vertical through-hole for driving-in the wedge.

The mount arm 105d is welded to the other side of the block 105b so as to horizontally extend outwardly. The inclined fixing plate 105e in a form of letter “L” is detachably fixed to a tip of the horizontal arm 105d by bolts and nuts. The plate 105e is fixed to the arm 105d in a condition that the plate is inclined backward at approximately 60 degrees. The horizontal member 104 provided with a pair of the upper and lower rails is fixed to the front face of the plate 105e by similar tightening of bolts and nuts.

The ring 105a is inserted into the recess 105f of the block 105b, and the wedge body 105c is pressed into the wedge driving-in hole and the wedge-receiving hole, whereby the connector 105 securely fixes the horizontal member 104 to the post 103.

Seeding and planting panels 106, each having the same construction as that of the aforementioned embodiments, are hung on the horizontal members 104. Since the horizontal member 104 is inclined backward, the seeding and planting plate 106 directs the front face of a seeding and planting block toward the sunlight. The inclined plate for fixing the horizontal member 104 is constituted to be adjustable in its angle, whereby the inclined angle of the panel 106 can be changed. This makes it possible to provide the temporary structural body for seeding and planting in which the panel 106 can follow the sunlight directions stepwise.

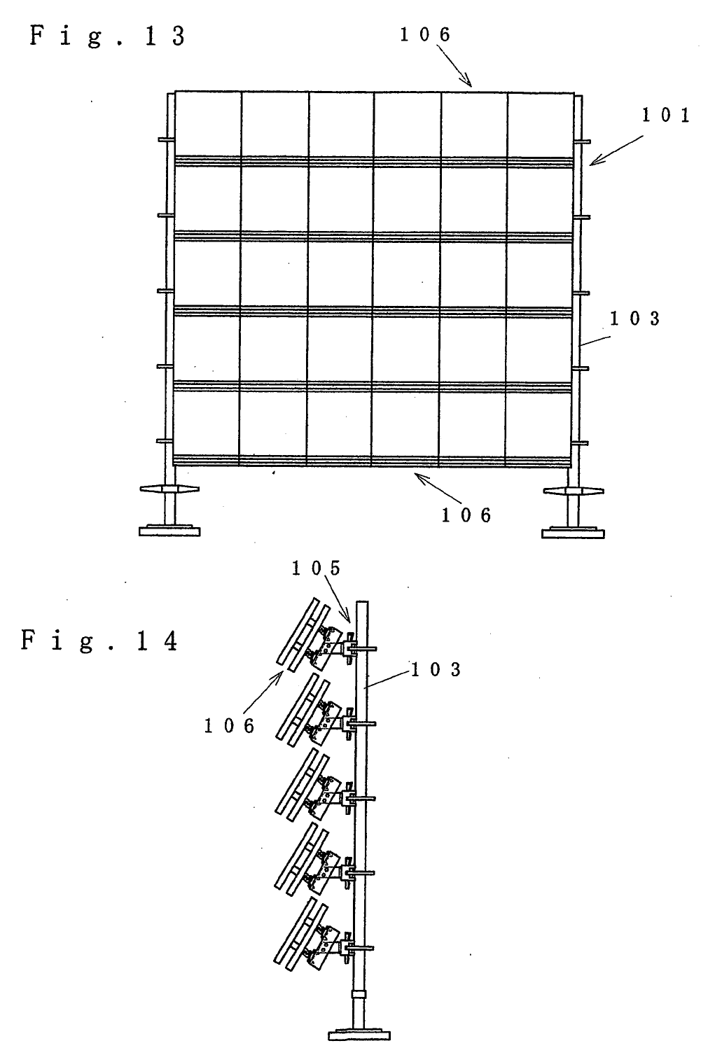

In the embodiment as shown in FIGS. 10 and 11, the temporary structural body for seeding and planting has the seeding and planting panels 106 horizontally continuously disposed and vertically spaced from one another. However, as shown in FIGS. 13 and 14, it is possible to adopt an arrangement in which the seeding and planting panels are continuously disposed horizontally and they are visually continuous vertically as seen from their front side.

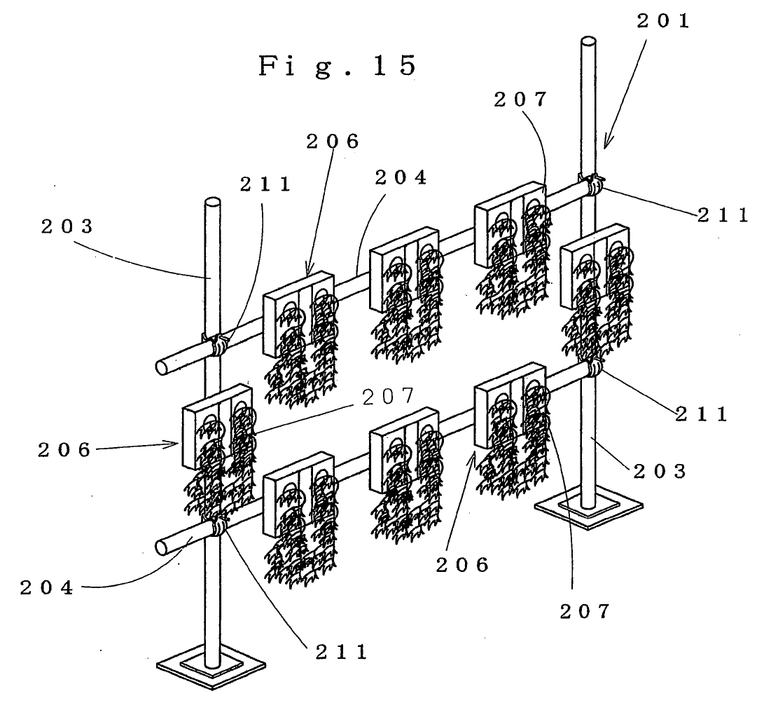

FIG. 15 is a perspective outside view showing an outdoor-installation type of temporary structural body for seeding and planting, which is another embodiment according to the present invention.

In this embodiment, horizontal members 204 of a supporting structure 201 are straight round pipes. The horizontal member 204 and a post 203 are fixedly secured at their intersection by a clamping device 211.

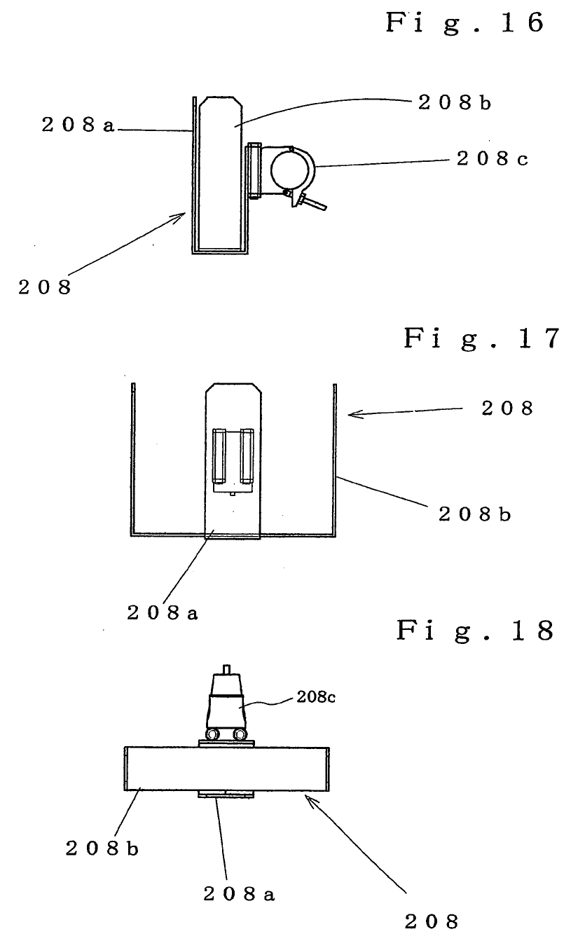

In this embodiment, a seeding and planting panel 206 is provided with a frame structure 208 as shown in FIGS. 16 to 18. The frame structure is constituted from a crossing frame piece 208a and a lateral frame piece 208b, which are band members with erected end portions and which intersect with each other in a cruciform formation at their bottom portions. A seeding and planting block 207 (FIG. 15) is vertically fitted into the frame structure 208. A clamping device 208c is fixed on the backside face of the frame piece 208a of the frame structure 208.

Therefore, the clamping device 208c of the frame structure 208 is attached to the horizontal member 204 in position, so that the seeding and planting panel 206 is carried by the supporting structure 2-1. Since the clamping device 208c is used as the mounting means, the seeding and planting panel 206 can be attached to the post 203 made of a round pipe (FIG. 15).

If desired, the horizontal member 204 or the post 203 is backwardly pulled from an appropriate position by a wire, so that the temporary structural body is reinforced.

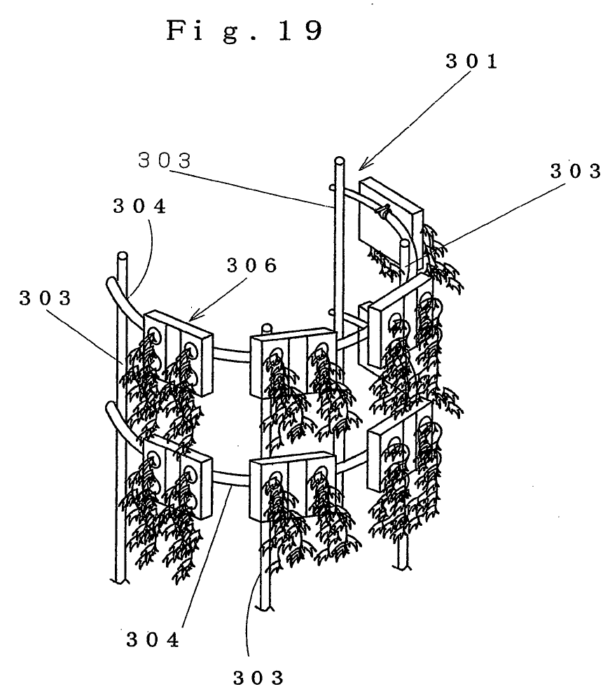

FIG. 19 is a perspective outside view showing the other embodiment of an outdoor-installation type of temporary structural body for seeding and planting.

In this embodiment, a horizontal member 304 constituting a supporting structure 301 is formed by a round pipe curving in a horseshoe shape. In order to horizontally support the horizontal members 304, posts 303 stand at four positions along the horizontal members 304. The horizontal members and the posts are connected at their intersections by welding or clamping devices.

Seeding and planting panels 306 with the same construction as that in FIGS. 16 to 18 are employed, and the panels 306 are mounted on the horizontal members 304 in positions by clamping devices on backside faces of frame structures.

Therefore, according to this temporary structural body for seeding and planting, the seeding and planting face can be continued vertically or horizontally, and also curved and projected forwardly.

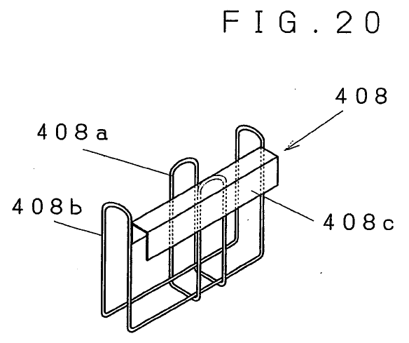

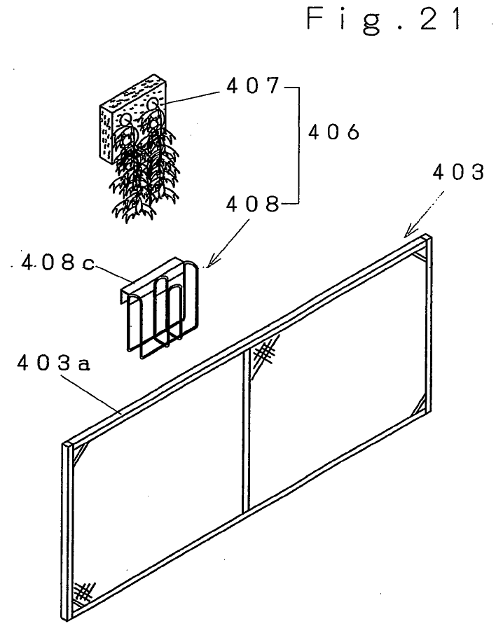

In an embodiment of FIGS. 20 and 21, a frame structure 408 of a seeding and planting panel 406 is formed by curving wire rods. The frame body 408 is primarily constituted from a crossing frame piece 408a and a lateral frame piece 408b intersecting at their bottom portions. The frame pieces 408a, 408b are configured to conform to the outline of the frame structure of the plate as shown in FIGS. 16 to 18. A seeding and planting block 407 is vertically fitted into the frame structure 408.

The frame structure of the seeding and planting panel of the embodiment in FIGS. 20 and 21 differs from that of the embodiment in FIGS. 16 to 18, in that the frame body 408 is formed by the wire rods, and that a fixing piece 408c, rather than a clamping device, is fixed to the backside face of the frame piece 408a as the mounting means, the piece 408c having a cross-section in a form of letter “C” opening downwardly.

This seeding and planting panel 406 is attached to a frame structure 403 as shown in FIG. 21 by fitting the fixing piece 408c to an upper frame portion 403a. For example, a curing panel provided scaffolding posts or the like can be used as the frame structure 403. A net portion of the frame structure is entwined with an ivy planted and grown in a seeding and planting block 407, so that the whole of the curing panel is used as a planting and growing face.

The outdoor-installation type temporary structural bodies for seeding and planting (FIGS. 10 to 21) can be also equipped with the irrigation system (not shown) as in the aforementioned indoor-installation type temporary structural body for seeding and planting. Supply of water or an effective fertilizing component by such an irrigation system can be controlled with use of a timer in consideration of changes in an external environment. Further, continuous observation data (for example, dried degree, pH, growing degree and presence or absence of harmful insects) may be compared with measured data in the normal condition with respect to soils, roots, leaves or flowers, wherein differences in the environments, diseases, harmful insects and other factors damaging health and growth of the plants are taken into consideration. When the observation data shift to a minus factor side, an appropriate treatment (spraying of pH adjuster, water, a chemical or the like) may be automatically performed.

Various types of the supporting structures can be provided by different combinations of the posts and the horizontal members. For example, the posts are stood at triangular three positions spaced a given distance, and a seeding and planting face can be formed in a triangular prism shape by installing the horizontal members across the adjacent posts in plural stages.

Further, a supporting structure with a self-standing framework can be constructed by front posts, rear posts backwardly spaced a distance from the front posts, joint rods connecting the front and rear posts, and the horizontal members connecting the adjacent front posts, and the horizontal members connecting the rear posts, whereby a temporary structural body having seeding and planting faces on both front and back sides can be provided.

### INDUSTRIAL APPLICABILITY

In the structural body for seeding and planting according to the present invention, the seeding and planting panels having the seeding and planting blocks contained in the frame structures are detachably mounted on the horizontal members or the posts of the supporting structure by the mounting means, whereby the seeding and planting face is formed, in which a large number of the seeding and planting panels are continuously or discontinuously disposed on the front face of the supporting structure. Therefore, it is possible to provide the temporary structural body which is not incorporated into a permanent construction, and which can be simply and readily assembled or disassembled.

Further, since the seeding and planting panels are independently mounted on the supporting structure by the mounting means, plural kinds of the seeding and planting blocks with desired plants can be combined arbitrarily. This is different from the panels permanently fixed to a wall surface or the like. Therefore, a desired seeding and planting face can be readily provided, and partial exchange and maintenance of the panels can be easily carried out.

Furthermore, the present structural body for seeding and planting is not integrally incorporated into a face to be greened, such as a wall surface of a building, but it can be constructed so as to facilitate its positioning, removal and movement. Therefore, the present structural body for seeding and planting can be used as an indoor and outdoor greening facility.

Further, according to the temporary structural body provided with the liquid feeding means, an appropriate amount of water, a liquid fertilizer or the like necessary for growing the plant can be timely fed to the seeding and planting blocks, even in the indoor installation.

When the mounting means are used for attaching the seeding and planting panels to the supporting structure in an inclined state, particularly in a case of outdoor installation, sunlight can be effectively given to the seeding and planting faces of the seeding and planting blocks. This can contribute to promotion of growth of the plant. Furthermore, when the inclination angle is adapted to be adjustable, the duration of possible sunshine on the seeding and planting blocks can be increased or decreased, in accordance with the kind of plant or the season.

1: A temporary structural body for seeding and planting, comprising:
seeding and planting panels, each having a frame structure in which a seeding and planting block is contained,
a supporting structure for the panels,
and mounting means for detachably mounting the panels on the supporting structure,
wherein said supporting structure includes at least two posts and a horizontal member installed between the posts, and
wherein backside faces or both sides of the panels are attached to the horizontal members or the posts with use of the mounting means, so that a seeding and planting face is formed by a number of the panels which are continuously or discontinuously disposed on a front face of the supporting structure.

2: The temporary structural body according to claim 1, further comprising a liquid feeding means for feeding water and/or liquid fertilizer to said panels.

3: The temporary structural body according to claim 1, wherein the seeding and planting block of said panel is made by planting and growing base material composed of a peat moss with seeds or seedlings being sown or planted therein.

4: The temporary structural body according to claim 1, wherein the frame structure of said panel comprises a peripheral frame made of a band plate material and surrounding an outer peripheral face of the seeding and planting block, and a backside frame overlaid on the block from its backside.

5: The temporary structural body according to claim 4, wherein the peripheral frame of the frame structure comprises a plurality of band plate members which surround the outer peripheral face of the seeding and planting block and which are spaced a required distance from each other in a direction of a depth of the block.

6: The temporary structural body according to claim 4, wherein the backside frame of said frame structure comprises a plurality of band plate members which is overlaid on the backside face of the seeding and planting block and which are spaced a distance vertically from each other.

7: The temporary structural body according to claim 1, wherein the frame structure is formed by wire rods which are bent in such a shape that the frame structure supports the seeding and planting block in its bottom portion, right and left portions and front and backside central portions.

8: The temporary structural body according to claim 1, wherein the frame structure is formed by band plate members which are bent in such a shape that the frame structure supports the seeding and planting block in its bottom portion, right and left portions and front and backside central portions.

9: The temporary structural body according to claim 1, wherein the supporting structure is self-sustainable.

10: The temporary structural body according to claim 1, wherein the supporting structure has the three posts standing in three positions spaced required spans and the horizontal members installed between the adjacent posts, and
the seeding and planting blocks are mounted on the horizontal members between the posts by said mounting means, so that three seeding and planting faces are formed.

11: The temporary structural body according to claim 1, wherein the supporting structure is formed by a self-sustainable framework, which is constituted from the front posts standing with a required span, the rear posts similarly standing with a required span behind the front posts, joining rods connecting the front posts with the rear posts, and horizontal members connecting the adjacent front or rear posts with each other, and
a number of the panels are mounted on the horizontal members, or the horizontal members and the posts, by the mounting means, so that the seeding and planting faces are formed on front and rear sides of the supporting structure.

12: The temporary structural body according to claim 1, wherein the horizontal member of the supporting structure is a straight rod member which is installed between the posts and which is formed in a rail-like shape with its groove upwardly opening, and the horizontal member constitutes the mounting means in cooperation with hanging members attached to backside faces of the seeding and planting panels; and
wherein the hanging members are engaged with the grooves of the horizontal members to be slidable in a longitudinal direction of the horizontal member, so that the panels are mounted on the supporting structure.

13: The temporary structural body according to claim 12, wherein said hanging member is a hooking member fixed to a backside frame of the seeding and planting panel.

14: The temporary structural body according to claim 1, wherein each of the horizontal members of said supporting structure is formed by a rod member curved in a generally horseshoe shape with a large curvature,
the horizontal members are vertically spaced from each other and fixed to the posts in longitudinally plural positions of the horizontal member, and
the seeding and planting panels which are mounted on the horizontal members by the mounting means are disposed to be vertically and horizontally spaced from each other.

15: The temporary structural body according to claim 1, wherein the posts and the horizontal members of the supporting structure are made of round pipes,
the mounting means is defined by clamping devices fixed to backside frame structures of the seeding and planting panels, and
the panels are detachably mounted on the horizontal members, or the horizontal members and the posts by the clamping devices.

16: The temporary structural body according to claim 1, wherein the mounting means mounts the seeding and planting panels on the supporting structure in a state that front faces of the seeding and planting blocks of the panels are backwardly inclined.

17: The temporary structural body according to claim 16, wherein the mounting means is constituted to be adjustable in a backward inclination angle of the seeding and planting block.

18: The temporary structural body according to claim 1, wherein a seeding and planting face, which has a number of the seeding and planting panels disposed in a continuous or discontinuous plane formation, is constructed on a front side of the supporting structure by the seeding and planting panels, the supporting structure and the mounting means.

19: The temporary structural body according to claim 2, wherein the liquid feeding means is provided with a liquid source, pipe lines for feeding the water or liquid fertilizer from the liquid source to each of the seeding and planting panels, nozzles at tips of the pipe lines for flowing out the water or liquid fertilizer, and a liquid feeding pump equipped on the pipe line on its way, and
the nozzles are detachably inserted into the seeding and planting blocks of the panels or inserted between the blocks, and the water or the liquid fertilizer is delivered to the panels through the pipe lines by the pump.

20: The temporary structural body according to claim 19, wherein the pipe lines comprise a main pipe equipped behind the seeding and planting panels, and a number of thin tubes branched forward from the main pipe; and
wherein the needle-like nozzles are attached to tips of the respective tubes for spraying the water or liquid fertilizer.

21: The temporary structural body according to claim 2, wherein the liquid feeding means is provided with a timer, so that a liquid feeding pump is driven at a preset time for supplying the seeding and planting panels with the water or liquid fertilizer.

22: The temporary structural body according to claim 2, wherein the supporting structure is provided at its lower portion with a detachable tray for receiving excess liquid from the seeding and planting panels, and the liquid in the tray is recycled to the liquid feeding means to be recirculated.

23: The temporary structural body according to claim 1, wherein a number of the seeding and planting panels are discontinuously disposed in a discontinuous plane formation between the supporting structures, and decorative panels and/or box-shaped panels are disposed in discontinuous sections, so that an overall front side of the supporting structure is covered with those panels, and
wherein the seeding and planting panels, the decorative panels and the box-shaped panels are detachably mounted on the supporting structure by the mounting means.

24: The temporary structural body according to claim 22, wherein backside faces of the decorative panels and the box-shaped panels are detachably mounted on the supporting structure by the mounting means.
